(19) United States
(12) Patent Application Publication
(10) Pub. No.: US 2017/0309913 A1
(43) Pub. Date: Oct. 26, 2017

(54) Negative Electrode Active Material for Lithium Ion Secondary Battery and Lithium Ion Secondary Battery

(71) Applicant: Hitachi, Ltd., Chiyoda-ku, Tokyo (JP)

(72) Inventors: Makoto OKAI, Tokyo (JP); Takashi KYOTANI, Miyagi (JP); Hirotomo NISHIHARA, Miyagi (JP); Takatoshi KASUKABE, Miyagi (JP)

(21) Appl. No.: 15/526,229

(22) PCT Filed: Nov. 14, 2014
(86) PCT No.: PCT/JP2014/080134

§ 371 Date: May 11, 2017

(51) Int. Cl. H01M 4/587; H01M 4/38; H01M 10/0525; H01M 4/04; H01M 4/02

(52) U.S. Cl. CPC H01M 4/587; H01M 10/0525; H01M 4/04; H01M 4/386; H01M 2004/027

(57) ABSTRACT

An object of the present invention is to provide a negative electrode active material for a lithium ion secondary battery, the negative electrode active material particularly having a high capacity and a long lifetime. A negative electrode material for a lithium ion secondary battery, containing: silicon nanoparticles; and silicon nanowires, wherein the silicon nanoparticles and the silicon nanowires are bound to each other. More preferably, the negative electrode active material for a lithium ion secondary battery, wherein a surface of the silicon nanoparticle or the silicon nanowire is covered with a carbon coating layer.

### TECHNICAL FIELD

The present invention relates to a negative electrode active material for a lithium ion secondary battery and a lithium ion secondary battery.

### BACKGROUND

Graphitic carbon materials are widely used as negative electrode active materials for lithium ion secondary batteries. A stoichiometric composition when lithium ions are charged in graphite is LiC₆, and a theoretical capacity thereof can be calculated to have 372 mAh/g.

On the other hand, a stoichiometric composition when lithium ions are charged in silicon is Li₁₅Si₄ or Li₂₂Si₅, and a theoretical capacity thereof can be calculated to have 3577 mAh/g or 4197 mAh/g. As such, silicon is an attractive material which can store lithium 9.6 times or 11.3 times larger than that in graphite. However, when lithium ions are charged in silicon particles, the volume is expanded about 2.7 times or 3.1 times. Thus, the silicon particles are dynamically destroyed during the repetition of charging and discharging lithium ions. When the silicon particles are destroyed, the destroyed fine silicon particles are electrically isolated. In addition, a new electrochemical coating layer can be formed on the destroyed surface to increase an irreversible capacity so that charge-discharge cycle characteristics are significantly decreased.

By forming the silicon particles into nanoparticles as a negative electrode active material of a lithium ion secondary battery, mechanical destroy according to charging and discharging of lithium ions can be prevented. However, there are problems in that some of the silicon nanoparticles are electrically isolated by a change in volume according to charging and discharging of lithium ions, and this causes large deterioration of lifetime characteristics.

Regarding such a problem, for example, NPL 1 describes an example in which silicon nanoparticles pulverized by a ball milling method to have a diameter of about 10 nm are applied to a negative electrode for a lithium ion secondary battery.

In addition, PTL 1 discloses a technique of forming a network of silicon particles and silicon nanowires on a carrier formed by copper or the like.

### CITATION LIST

### Patent Literature

PTL 1: JP 2008-269827 A

### Non Patent Literature

NPL 1: Energy Environ. Sci., 2013, 6, 2145-2155

### SUMMARY OF INVENTION

### Technical Problem

When silicon is pulverized by a ball mill to decrease a particle diameter as in NPL 1, electrical isolation due to expansion and contraction of silicon can be suppressed, but such suppression is not sufficient.

In addition, when the silicon nanowires are provided on the surface of silicon as in PTL 1, a broad electrical conduction path can be secured.

However, when the electrical conduction path is secured, there is a room for further improvement in contact points between the silicon particles and the silicon nanowires and the state of the surface.

The present invention is intended to solve such a problem, and an object thereof is to provide a negative electrode active material for a lithium ion secondary battery, the negative electrode active material particularly having a high capacity and a long lifetime.

### Solution to Problem

Here are features of the present invention for solving the problems mentioned above, for example.

A negative electrode material for a lithium ion secondary battery, containing: silicon nanoparticles; and silicon nanowires, wherein the silicon nanoparticles and the silicon nanowires are bound to each other.

In addition, more preferably, the negative electrode active material for a lithium ion secondary battery, wherein a surface of the silicon nanoparticle or the silicon nanowire is covered with a carbon coating layer.

### Advantageous Effects of Invention

According to the present invention, it is possible to realize a negative electrode active material for a lithium ion secondary battery, the negative electrode active material having a high capacity and a long lifetime. Problems, configurations, and advantageous effects which are other than noted above will be clarified from the following description of an embodiment.

### BRIEF DESCRIPTION OF DRAWINGS

FIG. 1 is a conceptual diagram of a structure in which silicon nanowires are bound to surfaces of silicon nanoparticles.

FIG. 2 is a conceptual diagram of a silicon particle.

FIG. 3 is a conceptual diagram illustrating a case where a carbon coating layer is formed on the surface of the silicon nanoparticle.

FIG. 4 is a conceptual diagram of the silicon nanowire.

FIG. 5 is a conceptual diagram illustrating a case where the carbon coating layer is formed on the surface of the silicon nanowire.

FIG. 6 is a conceptual diagram illustrating a bind form between the silicon nanoparticle and the silicon nanowire.

FIG. 7 is a conceptual diagram of the form of a binding portion between the silicon nanoparticle and the silicon nanowire when the carbon coating layer is formed.

FIG. 8 is an apparatus configuration diagram for describing a method for producing a negative electrode active material for a lithium ion secondary battery according to an example of the present invention.

FIG. 9 is a scanning electron micrograph of a negative electrode active material for a lithium ion secondary battery according to Example 1.

FIG. 10 is a scanning electron micrograph of the negative electrode active material for a lithium ion secondary battery according to Example 1.

FIG. 11 is a transmission electron micrograph of the negative electrode active material for a lithium ion secondary battery according to Example 1.

FIG. 12 is a transmission electron micrograph of the negative electrode active material for a lithium ion secondary battery according to Example 1.

FIG. 13 is a schematic diagram of a lithium ion secondary battery according to an example of the present invention.

FIG. 14 shows a result obtained by calculating weight ratio dependency of silicon on electrical capacity according to an example of the present invention.

FIG. 15 is a scanning electron micrograph of a negative electrode active material for a lithium ion secondary battery according to Example 2.

FIG. 16 is a scanning electron micrograph of the negative electrode active material for a lithium ion secondary battery according to Example 2.

FIG. 17 is a transmission electron micrograph of the negative electrode active material for a lithium ion secondary battery according to Example 2.

FIG. 18 is a transmission electron micrograph of the negative electrode active material for a lithium ion secondary battery according to Example 2.

FIG. 19 shows lifetime characteristic measurement results of lithium ion secondary batteries according to Examples 1 and 2 and Comparative Example.

### DESCRIPTION OF EMBODIMENTS

Hereinafter, embodiments of the present invention will be described by means of the drawings and the like. The following descriptions show specific examples of the contents of the present invention, and the present invention is not restricted to these descriptions and can be variously changed and modified by those skilled in the art within the scope of technical ideas disclosed in the present specification.

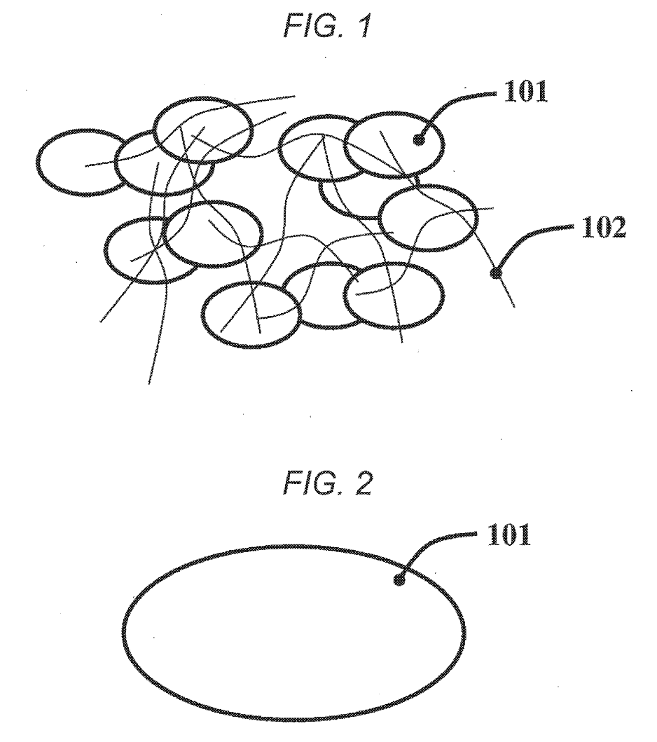

FIG. 1 is a conceptual diagram of a structure in which silicon nanowires 102 are bound to surfaces of silicon nanoparticles 101.

The silicon nanowires 102 are bound to the surfaces of the silicon nanoparticles 101. The silicon nanowires 102 are not only bound to the silicon nanoparticles 101 serving as starting points for silicon nanowire growth but also in contact with silicon nanoparticles therearound to form electrical paths. That is, the silicon nanowire 102 takes a role in providing an electrical path for keeping electrical conduction between the silicon nanoparticles 101 favorable. With a change in volume according to charging and discharging of lithium ions, some of the silicon nanoparticles 101 are electrically isolated, which leads to deterioration of lifetime characteristics. When the silicon nanowires 102, which are bound to and in contact with the silicon nanoparticles 101, are used as a constituent element for the negative electrode active material, it is possible to prevent the silicon nanoparticles 101 from being electrically isolated and to dramatically improve the lifetime characteristics.

FIG. 2 is a conceptual diagram of the silicon particle 101.

The silicon nanoparticle 101 can be approximated to an ellipsoid. A diameter of the silicon nanoparticle 101 is defined as an arithmetic average of a major axis and a minor axis of the silicon nanoparticle. The diameter of the silicon nanoparticle 101 needs to be 1 to 100 nm and more desirably 1 to 30 nm. When the diameter is 1 nm or less, a cohesion force between the silicon nanoparticles becomes strong, and as a result, the miniaturization effect is not manifested. In addition, when the diameter is 100 nm or more, there is a high possibility that the silicon nanoparticle is destroyed by mechanical strain according to charging and discharging of lithium ions. In order to prevent the silicon nanoparticle from, being destroyed even by mechanical strain due to high-speed charging and discharging, the diameter is desirably 30 nm or less. Regarding the silicon, particle 101, in addition to silicon particles having an elliptical shape, for example, silicon particles having a spherical shape or a scale shape can also be used.

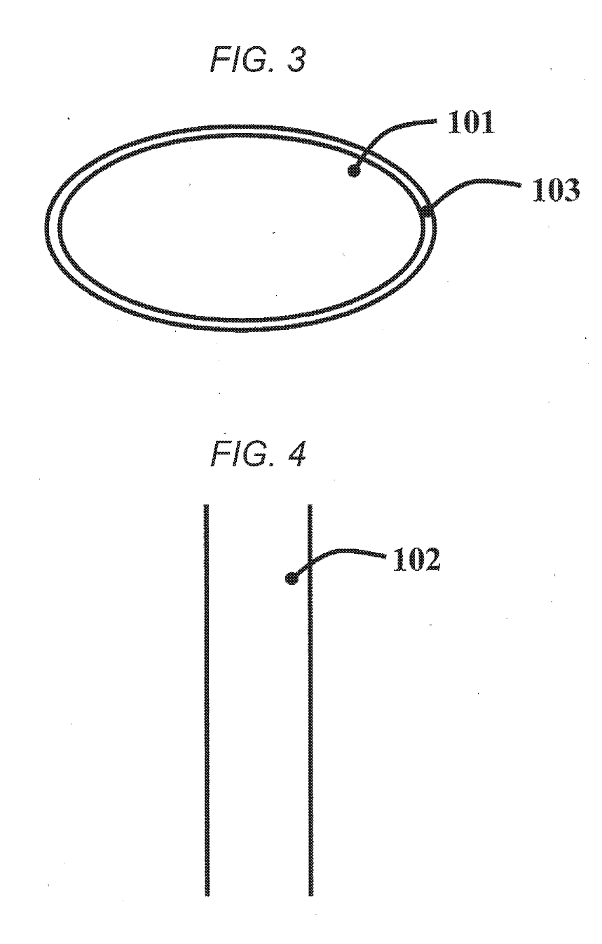

As illustrated in FIG. 3, a carbon coating layer 103 can be formed on the surface of the silicon nanoparticle 101. The electrical conductivity of the silicon nanoparticle 101 can be improved by the carbon coating layer 103. As the carbon coating layer 103, a nano graphene structure and amorphous carbon can be used. In particular, when the carbon coating layer 103 has a nano graphene structure, the carbon coating layer 103 has an electrical conductivity of 1000 S/m or more, and thus the electrical conductivity can be added to the silicon nanoparticle 101. The nano graphene structure is a structure in which carbons bound by an sp2 hybrid orbital have regular-layer structures, and has high conductivity. When the carbon coating layer does not have such a structure, particularly, high-speed charging and discharging characteristics can be improved. The thickness of the carbon coating layer 103 is desirably 0.5 to 100 nm. When the thickness is 0.5 nm or less, there is a technical difficulty to uniformly cover the surfaces of the silicon nanoparticles. In addition, when the thickness is 100 nm or more, there is a high possibility that the carbon coating layer 103 is peeled off from the surface of the silicon nanoparticle 101.

The silicon nanowire can be formed on the surface of the silicon particle 101 even when the carbon coating layer 103 is provided on the surface of the silicon particle 101.

FIG. 4 is a conceptual diagram of the silicon nanowire. The silicon nanowire 102 is wire-shaped silicon. When the shape of the silicon nanowire is assumed to be a circular cylinder, a cross-sectional diameter of the silicon nanowire 102 needs to be 1 to 100 nm and more desirably 1 to 30 nm. When the diameter is 1 nm or less, adhesion between the silicon nanowire and a silicon nanoparticle base material is weak, and thus there is a high possibility that the silicon nanowire is peeled off from the base material. In addition, when the diameter is 100 nm or more, there is a high possibility that the silicon nanowire is destroyed by mechanical strain according to charging and discharging of lithium ions. In order to prevent the silicon nanowire from being destroyed even by mechanical strain due to high-speed charging and discharging, the diameter is desirably 30 nm or less.

The diameter of the silicon nanowire can be adjusted by growth temperature of a nanowire to be described later. For example, when the growth temperature is around 1000° C., the diameter of the silicon nanowire is about 30 nm, and when the growth temperature is around 800° C., the diameter can be adjusted to about 10 nm.

Meanwhile, a length of the silicon nanowire can be appropriately adjusted by growth time of the silicon nanowire.

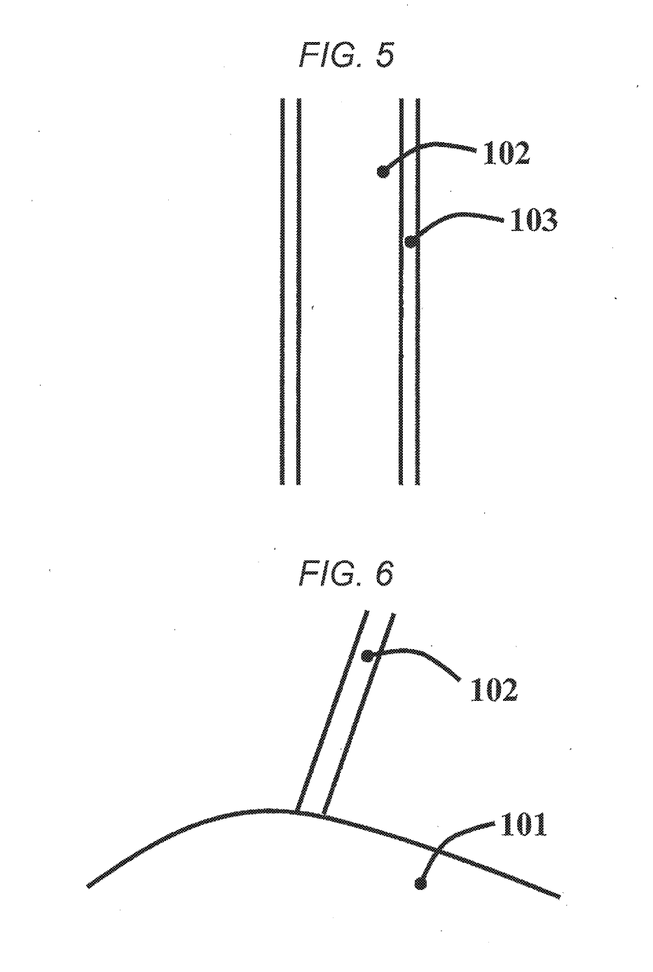

FIG. 5 is a conceptual diagram illustrating a case where the carbon coating layer 103 is formed on the surface of the silicon nanowire 102.

The electrical conductivity of the silicon nanowire 102 can be improved by the formation of the carbon coating layer 103 on the surface of the silicon nanowire 102. As the carbon coating layer 103, a nano graphene structure and amorphous carbon can be used. In particular, when the carbon coating layer 103 has a nano graphene structure, the carbon coating layer 103 has an electrical conductivity of 1000 S/m or more, and thus the electrical conductivity can be added to the silicon nanowire 102. According to this, particularly, high-speed charging and discharging characteristics can be improved. The thickness of the carbon coating layer 103 is desirably 0.5 to 100 nm. When the thickness is 0.5 nm or less, there is a technical difficulty to uniformly cover the surface of the silicon nanowire 102. In addition, when the thickness is 100 nm or more, there is a high possibility that the carbon coating layer 103 is peeled off from the surface of the silicon nanowire 102.

FIG. 6 is a conceptual diagram illustrating a bind form between the silicon nanoparticle 101 and the silicon nanowire 102. The silicon nanowire 102 is bound to the surface of the silicon nanoparticle 101. The silicon nanoparticle 101 and the silicon nanowire 102 are formed by silicon atoms, and the silicon nanoparticle 101 and the silicon nanowire 102 are strongly bound to each other by covalent binding of silicon atoms at a binding interface between the silicon nanoparticle 101 and the silicon nanowire 102. The silicon nanowire 102 is bound to the surface of the silicon nanoparticle 101 with the cross-section, which has a certain angle with respect to the axis direction, interposed therebetween.

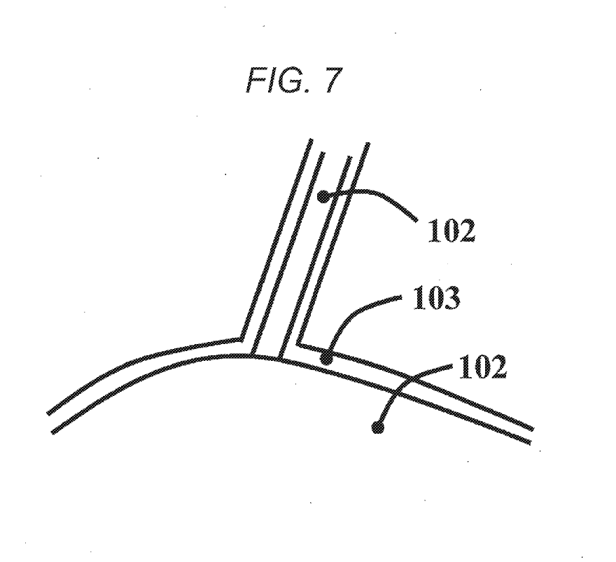

FIG. 7 is a conceptual diagram of the form of a binding portion between the silicon nanoparticle and the silicon nanowire when the carbon coating layer is formed. When the carbon coating layer is formed, the silicon nanowire 102 is grown on the surface of the silicon nanoparticle 101, and then the carbon coating layer 103 is formed. The form of the carbon coating layer 103 at the binding portion between the silicon nanoparticle 101 and the silicon nanowire 102 is as illustrated in FIG. 7. That is, the form of the carbon coating layer 103 is the form in which the entire binding portion between the silicon nanoparticle 101 and the silicon nanowire 102 is covered with the carbon coating layer 103. As the carbon coating layer 103, a nano graphene structure and amorphous carbon can be used. In particular, when the carbon coating layer 103 has a nano graphene structure, the carbon coating layer 103 has an electrical conductivity of 1000 S/m or more, and thus the electrical conductivity can be added to the silicon nanoparticle 101 and the silicon nanowire 102. According to this, particularly, high-speed charging and discharging characteristics can be improved. The thickness of the carbon coating layer 103 is desirably 0.5 to 100 nm. When the thickness is 0.5 nm or less, there is a technical difficulty to uniformly cover the surfaces of the silicon nanoparticle 101 and the silicon nanowire 102. In addition, when the thickness is 100 nm or more, there is a high possibility that the carbon coating layer 602 is peeled off from the surfaces of the silicon nanoparticle 101 and the silicon nanowire 102.

By providing the carbon coating, it is possible to improve electrical conduction as well as Li ion conduction between the silicon nanoparticles by the network of the silicon nanowires.

### EXAMPLE 1

Hereinafter, the present invention will be described in more detail by means of Examples, but the present invention is not limited to these Examples.

### (Pulverization Step)

The silicon nanoparticles 101 were produced by pulverizing a bulk silicon material by a bead mill. To 500 mL of isopropyl alcohol, 100 g of silicon particles were added, and the resultant mixture was stirred well and then pulverized at a circumferential velocity of 100 mL/min for 90 min by using a bead mill apparatus charged with 200 g of zirconia beads having a diameter of 300 μm.

The silicon nanoparticles 101 can be produced from a bulk silicon material by various pulverization methods as well as by pulverization using a bead mill. In addition, the silicon nanoparticles can be also produced by growing silicon by a gas phase evaporation method such as laser ablation.

### (Silicon Nanowire Growth Step)

The silicon nanowires 102 can be produced using silicon nanoparticles as a base material by a thermal vapor deposition method in a state where the silicon nanowires are bound to the surfaces of the silicon nanoparticles. In addition, the silicon nanowires can be produced by various deposition methods.

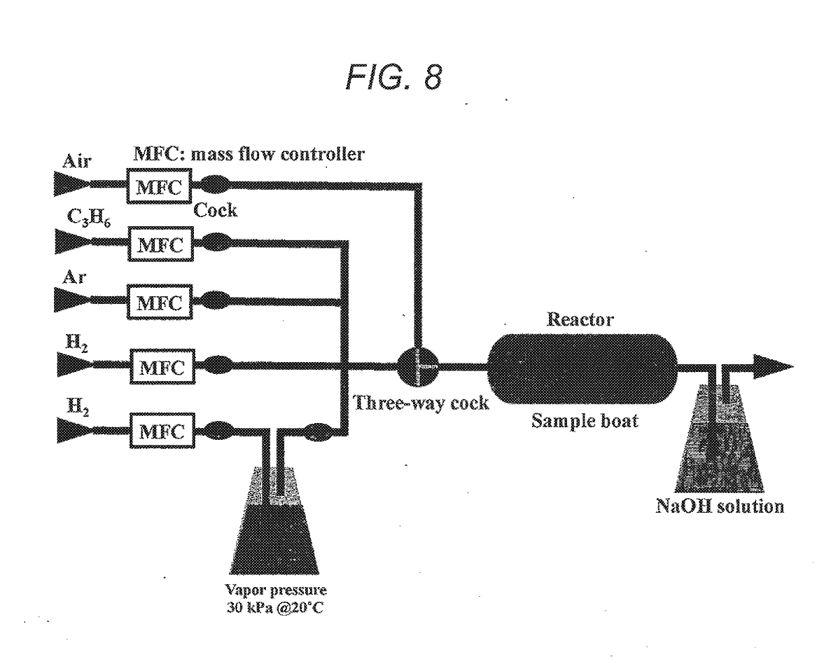

FIG. 8 is a schematic diagram of a thermal vapor deposition apparatus for forming the silicon nanowires on the surfaces of the silicon nanoparticles and further performing carbon coating thereon.

Liquid silicon tetrachloride was used as a raw material of silicon and the silicon tetrachloride was introduced into a reactor by bubbling with hydrogen gas. The vapor pressure of silicon tetrachloride at 20° C. is 30 kPa and the amount of silicon tetrachloride introduced by bubbling is 34%. Herein, in order to introduce silicon tetrachloride at an amount equal to or less than 34%, it is necessary to cool silicon tetrachloride or to provide a separate line of hydrogen gas. In FIG. 8, a hydrogen line in which bubbling is not performed was separately provided and was converged with a bubbling line to introduce silicon tetrachloride into the reactor. The procedures of growing carbon-covered silicon nanoparticles and carbon-covered silicon nanowires are as follows.

The silicon nanoparticles are input in a sample boat, and the sample boat is disposed near the center of the reactor. The reactor is made of quartz and has a diameter of 5 cm and a length of 40 cm. In the upper hydrogen line of FIG. 8, hydrogen was allowed to flow at a flow rate of 200 mL/min, and the temperature of a growth furnace was increased from room temperature to 1000° C. at an increasing rate of 10° C./min in a state where the lower bubbling hydrogen line is closed. During the temperature increasing process, a native oxide film formed on the surface of the silicon nanoparticle can be reduced.

Next, when the temperature reached 1000° C., the flow rate in the upper hydrogen line was changed to 160 mL/min and the flow rate in the hydrogen line of the lower bubbling hydrogen line was set to 40 mL/min. Under this condition, 6.8% silicon tetrachloride can be introduced. After growth at 1000° C. for 3 hr, the lower bubbling hydrogen line was closed, the flow rate in the upper hydrogen line was changed to 200 mL/min and then held at 1000° C. for 30 mm. According to this, the silicon nanowires can be produced on the surfaces of the silicon nanoparticles serving as a base material.

### (Carbon Coating Step)

Thereafter, both the hydrogen lines were closed, argon gas was allowed to flow at a flow rate of 200 mL/min, and the temperature was decreased at a decreasing rate of 10° C./min to 800° C. When the temperature reached 800° C., propylene gas was introduced at a flow rate of 10 mL/min, and at the same time, the flow rate of argon gas was set to 190 mL/min, and then the carbon coating layer was grown for 1 nr.

Thereafter, a propylene gas line was closed, argon gas was allowed to flow at a flow rate of 200 mL/min and held for 30 min, and then natural cooling was performed. According to this, the carbon coating layer (thickness: 5 nm) having a nano graphene multi-layer structure can be produced on the surfaces of the silicon nanoparticle and the silicon nanowire. When the production of the silicon nanowires on the silicon nanoparticles and the production of the carbon coating layer subsequent to the production of the silicon nanowires were sequentially performed in this way, the formation of the native oxide film on the surfaces of the silicon nanoparticle and the silicon nanowire is prevented and thus a reducing and removing process of the native oxide film after the growth of the silicon nanowires is not necessary.

Incidentally, in FIG. 8, in order to prevent surface oxidation of the silicon nanoparticles and the silicon nanowires, the production of the silicon nanowires on the silicon nanoparticles and the production of the carbon coating layer subsequent to the production of the silicon nanowires were sequentially performed. The silicon nanowires are grown on the silicon nanoparticles and then taken out once in air, a heat treatment is then performed in a reducing atmosphere to remove the native oxide film on the surfaces of the silicon nanoparticle and the silicon nanowire, and the carbon coating-layer can also be sequentially produced. When the growth of the silicon nanowires on the silicon nanoparticles and the production of the carbon coating layer are separately performed in the reactor, productivity is improved. In addition, when the temperature when the silicon nanowires are grown on the silicon nanoparticles, the amount of silicon tetrachloride introduced, and the growth time are changed, the diameter and the growth amount of silicon nanoparticle can be controlled. Further, by changing the growth time of the carbon coating layer, the thickness of the carbon coating layer can be controlled. Furthermore, for the production of the carbon coating layer, in addition to propylene gas, various hydrocarbon gases such as acetylene gas, propane gas, and methane gas can be used.

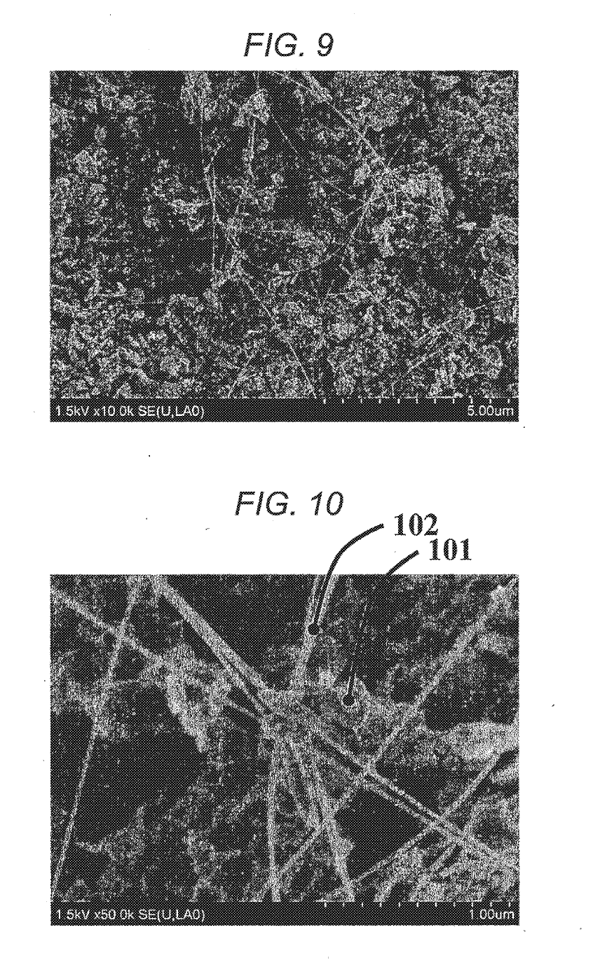

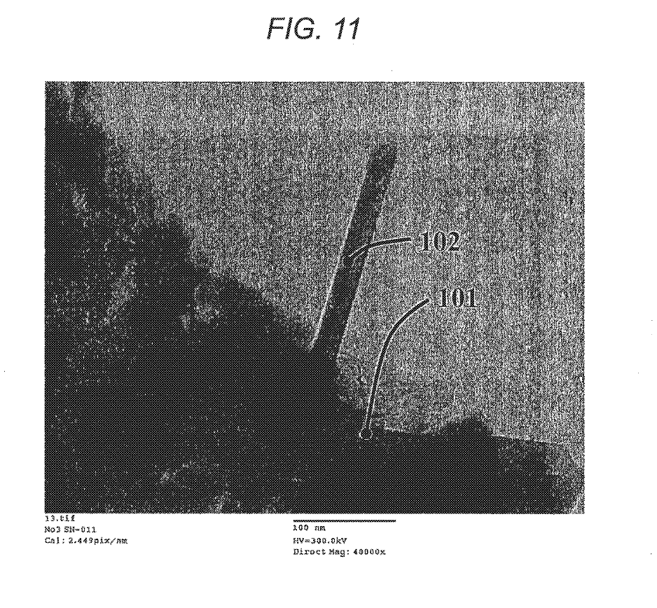

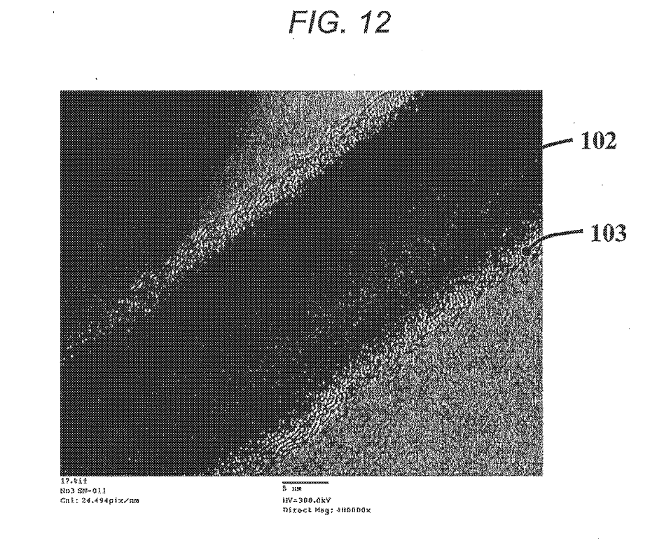

A composite active material of the silicon nanoparticles and the silicon nanowires produced as described above was observed with a scanning electron microscope. Photographs are shown in FIGS. 9 and 10, and transmission electron micrographs thereof are shown in FIGS. 11 and 12. From FIG. 9, it is found that the silicon nanoparticles and the silicon nanowires are mixed. In addition, as seen from the center part of FIG. 10, it is found that the silicon nanoparticles and the silicon nanowires are bound to each other. Further, from FIG. 11, a state is found in which the silicon nanowire is grown from the surface of the silicon nanoparticle. In addition, from FIG. 12, it is found that the diameter of the silicon nanowire is 35 nm and the thickness of the carbon coating layer is 5 nm. Moreover, since a layer structure is shown in the portion of the carbon coating layer, it can be determined that the carbon coating layer has a nano graphene structure.

### (Production of Lithium Ion Secondary Battery)

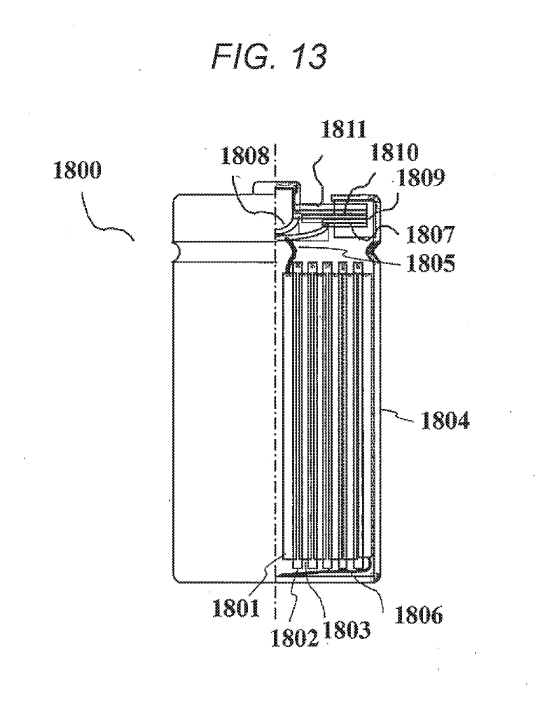

FIG. 13 is a conceptual diagram of a lithium ion secondary battery 1800 using the silicon nanowire-silicon nanoparticle negative electrode active material produced as described above.

The lithium ion secondary battery 1800 includes a positive electrode 1801, a separator 1802, a negative electrode 1803, a battery can 1804, a positive electrode current collector tab 1805, a negative electrode current collector tab 1806, an inner cover 1807, an internal pressure release valve 1808, a gasket 1809, a positive temperature coefficient (PTC) resistive element 1810, and a battery cover 1811. The battery cover 1811 is an integrated component formed by the inner cover 1807, the internal pressure release valve 1808, the gasket 1809, and the positive temperature coefficient resistive element 1810.

The positive electrode 1801 was produced by the following procedures. LiMn₂O₄ was used as a positive electrode active material. To 85.0 wt % of the positive electrode active material, 7.0 wt % of graphite powder and 2.0 wt % of acetylene black were added as a conductive material. Further, a solution obtained by dissolving 6.0 wt % of polyvinylidene fluoride (hereinafter, abbreviated as PVDF) in 1-methyl-2-pyrrolidone (hereinafter, abbreviated as NMP) was added as a binder, the resultant solution was mixed by a planetary mixer, and further air bubbles in the slurry were removed under vacuum, thereby preparing a homogeneous positive electrode mixture slurry. This slurry was applied uniformly and evenly onto both surfaces of an aluminum foil having a thickness of 20 μm by using an applicator. After applying the slurry, compression molding was performed thereon by a roll press machine to have an electrode density of 2.55 g/cm³. The obtained product was cut by a cutting machine to produce the positive electrode 1201 having a thickness of 100 μm, a length of 900 mm, and a width of 54 mm.

In this Example, LiMn₂O₄ has been used as the positive electrode active material, but for example, in addition thereto, LiCoO₂, LiNiO₂, and LiMn₂O₄ can be used. In addition, it is possible to use LiMnO₃, LiMn₂O₃, LiMnO₂, Li₄Mn₅O₁₂, LiMn₂₋ₓMxO₂ (provided that, M=at least one selected from the group consisting of Co, Ni, Fe, Cr, Zn, and Ti, x=0.01 to 0.2), Li₂Mn₃MO₈ (provided that, M=at least one selected from the group consisting of Fe, Co, Ni, Cu, and Zn) , Li₁₋ₓAₓMn₂O₄ (provided that, A=at least one selected from the group consisting of Mg, B, Al, Fe, Co, Ni, Cr, Zn, and Ca, x=0.01 to 0.1), LiNi₂₋ₓMₓO₂ (provided that, M=at least one selected from the group consisting of Co, Fe, and Ga, x=0.01 to 0.2), LiFeO₂, Fe₂ (SO₄)₃, LiCo₁₋ₓMₓO₂ (provided that, M=at least one selected from the group consisting of Ni, Fe, and Mn, x=0.01 to 0.2), LiNi₁₋ₓMₓO₂ (provided that, M=at least one selected from the group consisting of Mn, Fe, Co, Al, Ga, Ca, and Mg, x=0.01 to 0.2), Fe (MoO₄)₃, FeF₃, LiFePO₄, LiMnPO₄, and the like.

The negative electrode 1803 was produced by the following procedures. A silicon nanowire-silicon nanoparticle negative electrode active material was used as the negative electrode active material. To 95.0 wt % of this negative electrode active material, a solution obtained by dissolving 5.0 wt % of PVDF in NMP was added as a binder. The resultant solution was mixed by a planetary mixer, and air bubbles in the slurry were removed under vacuum, thereby preparing a homogeneous negative electrode mixture slurry. This slurry was applied uniformly and evenly onto both surfaces of a rolled copper foil having a thickness of 10 μm by using an applicator. After applying the slurry, this electrode was subjected to compression molding by a roll press machine to have an electrode density of 1.3 g/cm³. The obtained product was cut by a cutting machine to produce the negative electrode 1803 having a thickness of 110 μm, a length of 950 mm, and a width of 56 mm.

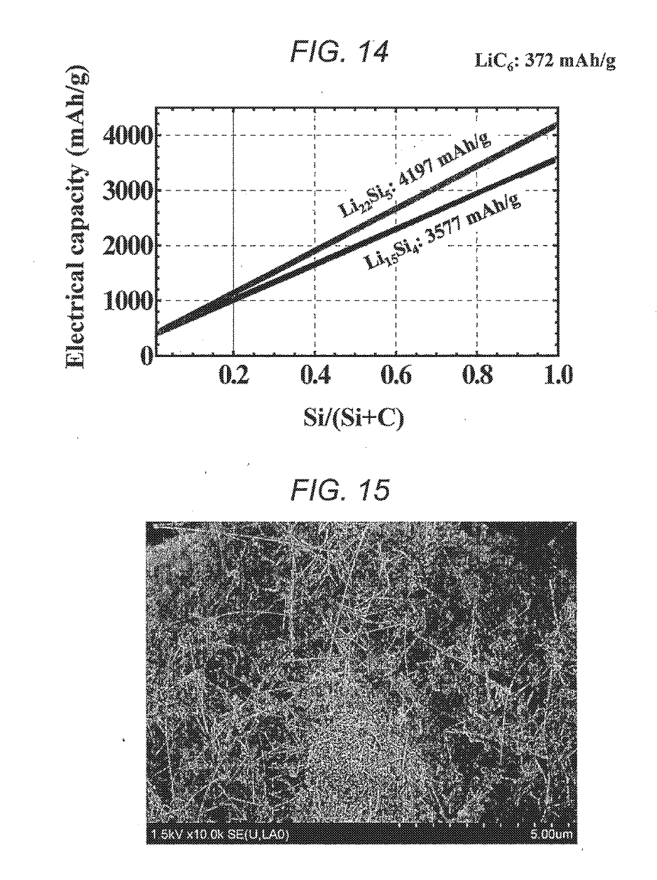

The aforementioned composite material of the silicon nanoparticles and the silicon nanowires can not only be used alone as a negative electrode active material, but also be used as a negative electrode active material by mixing the composite material with various kinds of negative electrode active material. As an example, a case where the composite material is mixed with a material containing carbon as a main component, for example, a graphite material and then used is considered. FIG. 14 shows the result obtained by calculating the silicon weight ratio dependency on the electrical capacity. Regarding carbon, a stoichiometric composition when lithium ions are charged in carbon was assumed to LiC₆ and the electrical capacity thereof was adjusted to 372 mAh/g. In addition, regarding silicon, the silicon weight ratio dependency on the electrical capacity was calculated in each of a case where a stoichiometric composition when lithium ions are charged in silicon was assumed to Li₁₅Si₄ and the electrical capacity thereof was adjusted to 3577 mAh/g and a case where a stoichiometric composition when lithium ions are charged in silicon was assumed to Li₂₂Si₅ and the electrical capacity thereof was adjusted to 4197 mAh/g. In Si/(Si+C) of the horizontal axis, Si indicates the total weight of the silicon nanoparticles and the silicon nanowires, and C indicates the total weight of the weight of the carbon coating layer on the silicon nanoparticles and the silicon nanowires and the weight of graphite. By changing the silicon weight ratio, the electrical capacity control can be widely performed in a range from the electrical capacity peculiar to carbon to the electrical capacity peculiar to silicon.

As a material having carbon to be mixed as a main component, natural graphite, synthetic graphite, natural graphite covered with amorphous carbon, synthetic graphite covered with amorphous carbon, nanoparticulate carbon, carbon nanotube, nanocarbon, and the like can be used.

The positive electrode current collector tab 1805 and the negative electrode current collector tab 1806 are ultrasonic welded to uncoated portions (current collector plate exposure surfaces) of the positive electrode 1801 and the negative electrode 1803 produced as described above, respectively. An aluminum lead piece was used for the positive electrode current collector tab 1805 and a nickel lead piece was used for the negative electrode current collector tab 1806.

Thereafter, the separator 1802 formed by a porous polyethylene film having a thickness of 30 μm is inserted between the positive electrode 1801 and the negative electrode 1803, and the positive electrode 1801, the separator 1802, and the negative electrode 1803 are wound. This winding body is stored in the battery can 1804, and the negative electrode current collector tab 1806 is connected to the can bottom of the battery can 1804 by a resistance welder. The positive electrode current collector tab 1805 is connected to the bottom surface of the inner cover 1807 by ultrasonic welding.

A nonaqueous electrolyte is injected before the battery cover 1811 of the upper part is attached to the battery can 1804. An electrolyte solvent is composed of ethylene carbonate (EC), dimethyl carbonate (DMC), and diethyl carbonate (DEC) at a volume ratio of 1:1:1. As the electrolyte, LiPF₆ having a concentration of 1 mol/L (about 0.8 mol/kg) was used. A lithium ion secondary battery can be obtained by adding such an electrolyte dropwise from the above of the winding body, and crimping and sealing the battery cover 1211 to the battery can 1204.

In this Example, as a solvent, ethylene carbonate (EC), dimethyl carbonate (DMC), and diethyl carbonate (DEC) are used at a volume ratio of 1:1:1. However, as another solvent, propylene carbonate, butylene carbonate, γ-butyrolactone, diethyl carbonate, 1,2-dimethoxyethane, 2-methyltetrahydrofuran, dimethyl sulfoxide, 1,3-dioxolane, formamide, dimethylformamide, methyl propionate, ethyl propionate, phosphate triester, trimethoxymethane, dioxolane, diethylether, sulfolane, 3-methyl-2-oxazolidinone, tetrahydrofuran, 1,2-diethoxyethane, chloroethylene carbonate, chlorpropylene carbonate, or the like can be used, and the volume ratio thereof can be appropriately adjusted.

Next, scanning electron micrographs of the composite material (presence of carbon coating) of the silicon nanoparticles and the silicon nanowires actually produced are shown in FIGS. 9 and 10, and transmission electron micrographs thereof are shown in FIGS. 11 and 12. From FIG. 9, it is found that the silicon nanoparticles and the silicon nanowires are mixed. In addition, as seen from the center part of FIG. 10, it is found that the silicon nanoparticles and the silicon nanowires are bound to each other. Further, from FIG. 11, a state is found in which the silicon nanowire is grown from the surface of the silicon nanoparticle. In addition, from FIG. 12, it is found that the diameter of the silicon nanowire is 35 nm and the thickness of the carbon coating layer is 5 nm. Moreover, since a layer structure is shown in the portion of the carbon coating layer, it can be determined that the carbon coating layer has a nano graphene structure.

### (Evaluation)

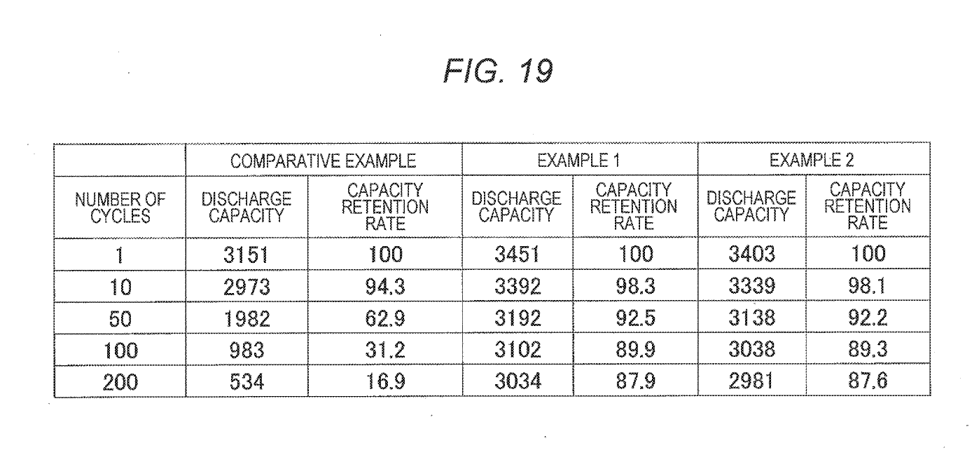

FIG. 19 snows results of evaluating lifetime characteristics by using a composite material of the silicon nanoparticles and the silicon nanowires of the present invention alone as an electrode active material and using a counter electrode lithium coin battery. The lifetime characteristics were evaluated on the basis of a discharge capacity and a capacity retention rate (the first cycle is assumed to 100) after 1, 10, 50, 100, and 200 cycles.

### EXAMPLE 2

In Example 2, silicon nanoparticles were produced by pulverizing a bulk silicon material by a planetary ball mill. Production of a silicon nanowire-silicon nanoparticle negative electrode active material, production of a battery, and evaluation were performed in the similar manner to Example 1 except the above-described operation.

### (Pulverization Step)

To a zirconia container having a capacity of 45 mL, 2 g of silicon particles and 20 g of zirconia beads (diameter: 100 μm) were added, 6 mL of isopropyl alcohol was added thereto, and then the obtained product was pulverized at a rotation number of 1100 rpm for 80 min.

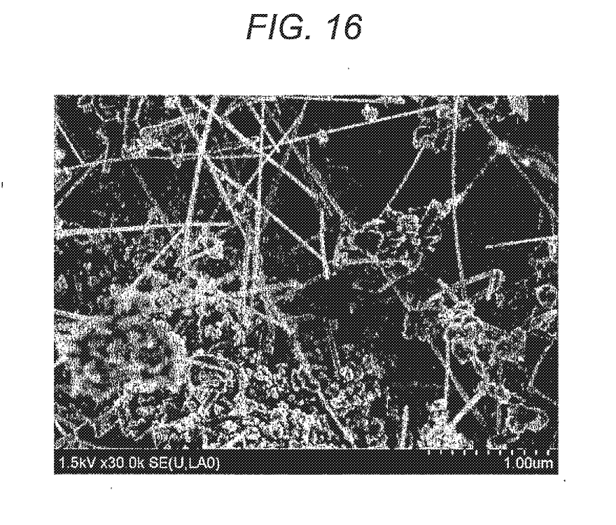

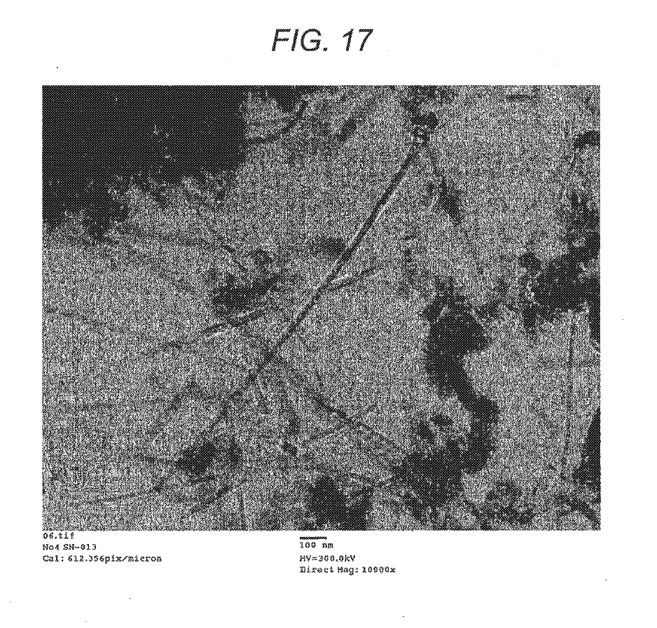

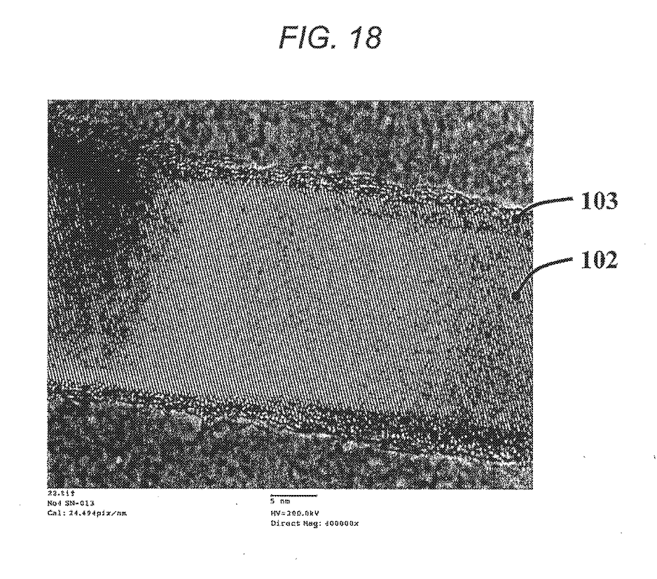

Scanning electron micrographs of the composite material (presence of carbon coating) of the silicon nanoparticles and the silicon nanowires produced are shown in FIGS. 15 and 16, and transmission electron micrographs thereof are shown in FIGS. 17 and 18. From FIG. 15, it is found that the silicon nanoparticles and the silicon nanowires are mixed. The amount of the silicon nanowires is considerably larger than that in FIG. 9, and the reason for this is considered that there is a difference in surface activity of the silicon nanoparticles used as a base material. In addition, as seen from the right part of FIG. 16, it is found that the silicon nanoparticles and the silicon nanowires are bound to each other. Further, as seen from the lower right part of FIG. 17, a state is found in which the silicon nanowires are grown from the surfaces of the silicon nanoparticles. In addition, from FIG. 18, it is found that the diameter of the silicon nanowire is 42 nm and the thickness of the carbon coating layer is 5 nm. Moreover, since a layer structure is shown in the portion of the carbon coating layer, it can be determined that the carbon coating layer has a nano graphene structure.

### COMPARATIVE EXAMPLE

For comparison, a battery was produced by using the silicon nanoparticles alone as an electrode active material and evaluation was performed thereon. The production of the battery and the evaluation were performed in the similar manner to Example 1 except the production of a negative electrode.

The negative electrode 1803 was produced by the following procedures. For a negative electrode active material, silicon nanoparticles were used alone as the negative electrode active material. To 95.0 wt % of this negative electrode active material, a solution obtained by dissolving 5.0 wt % of PVDF in NMP was added as a binder. The resultant solution was mixed by a planetary mixer, and air bubbles in the slurry were removed under vacuum, thereby preparing a homogeneous negative electrode mixture slurry. This slurry was applied uniformly and evenly onto both surfaces of a rolled copper foil having a thickness of 10 μm by using an applicator. After applying the slurry, this electrode was subjected to compression molding by a roll press machine to have an electrode density of 1.3 g/cm³. The obtained product was cut by a cutting machine to produce the negative electrode 1803 having a thickness of 110 μm, a length of 950 mm, and a width of 56 mm.

Evaluation results of Examples 1 and 2 and Comparative Example are shown in FIG. 19. As a result of comparing Examples 1 and 2 and Comparative Example, in the case of the composite material of the silicon nanoparticles and the silicon nanowires of the present invention, it can be confirmed that lifetime characteristics are considerably improved.

### REFERENCE SIGNS LIST

101 silicon nanoparticle
102 silicon nanowire
103 carbon coating layer
1800 lithium ion secondary battery
1801 positive electrode
1802 separator
1803 negative electrode
1804 battery can
1805 positive electrode current collector tab
1806 negative electrode current collector tab
1807 inner cover
1808 pressure release valve
1809 gasket
1810 positive temperature coefficient resistive element (PTC element)
1811 battery cover

1. A negative electrode material for a lithium ion secondary battery, comprising:
silicon nanoparticles; and
silicon nanowires, wherein
the silicon nanoparticles and the silicon nanowires are bound to each other.

2. The negative electrode for a lithium ion secondary battery according to claim 1, wherein
a diameter of the silicon nanoparticle is 1 to 100 nm, and a diameter of the silicon nanowire is 1 to 100 nm.

3. The negative electrode of a lithium ion secondary battery according to claim 2, wherein
a diameter of the silicon nanoparticle is 1 to 30 nm, and a diameter of the silicon nanowire is 1 to 30 nm.

4. The negative electrode active material for a lithium ion secondary battery according to claim 1, wherein
a surface of the silicon nanoparticle or the silicon nanowire is covered with a carbon coating layer.

5. The negative electrode active material for a lithium ion secondary battery according to claim 4, wherein
the carbon coating layer has a nano graphene structure.

6. The negative electrode active material for a lithium ion secondary battery according to claim 4, wherein
a thickness of the carbon coating layer is 0.5 to 100 nm.

7. A negative electrode active material for a lithium ion secondary battery, being obtained by mixing the negative electrode active material for a lithium ion secondary battery according to claim 1 and a material containing carbon as a main component.

8. The negative electrode active material for a lithium ion secondary battery according to claim 7, wherein
the material containing carbon as a main component is any one of natural graphite, synthetic graphite, natural graphite covered with amorphous carbon, synthetic graphite covered with amorphous carbon, nanoparticulate carbon, carbon nanotube, and nanocarbon.

9. The negative electrode active material for a lithium ion secondary battery according to claim 7, wherein
a ratio of the silicon nanoparticles is 5 to 95 wt % with respect to the total weight of the silicon nanoparticles and the silicon nanowires.

10. A lithium ion secondary battery comprising:
a positive electrode; and
a negative electrode, wherein
the negative electrode includes a negative electrode mixture, and
the negative electrode mixture contains the negative electrode active material of a lithium ion secondary battery according to claim 1.
